(19) United States
(12) Patent Application Publication
(10) Pub. No.: US 2016/0293130 A1
(43) Pub. Date: Oct. 6, 2016

(54) DISPLAY DEVICE

(71) Applicant: Sharp Kabushiki Kaisha, Osaka (JP)

(72) Inventor: Takenobu NISHIGUCHI, Osaka-shi (JP)

(21) Appl. No.: 15/103,443

(22) PCT Filed: Sep. 10, 2014
(86) PCT No.: PCT/JP2014/073881

§ 371 Date: Jun. 10, 2016

(30) Foreign Application Priority Data
Jan. 15, 2014 (JP) 2014-005292

(51) Int. Cl. G09G 3/36; G09G 3/20

(52) U.S. Cl. CPC G09G 3/3688; G09G 3/3677; G09G 3/2003; G09G 3/3696; G09G 2320/0646; G09G 2320/0666; G09G 2300/0809

(57) ABSTRACT

In order to suppress an increase in number of transmission signal lines such as cables and the like while using an interface based on an existing standard, in a liquid crystal display device (10) that adopts a field sequential method, a signal processing circuit (15) rearranges gradation data to data arrangement suitable for the field sequential drive, and transmits drive video signal data indicating a red gradation value through transmission paths for G data and B data in a first HDMI cable (HC1). In this manner, since in the HDMI cable that can transmit RGB in parallel, three pieces of display gradation data of the same color (equivalent to three pixels) are transmitted in parallel, a number of the HDMI cables for the transmission is one.

### TECHNICAL FIELD

The present invention relates to a display device, and more particularly to a display device such as a liquid crystal display device that performs color display by a field sequential method.

### BACKGROUND ART

In recent years, a liquid crystal display device adopting a field sequential method that performs color display without using a color filter has attracted attention. In this field sequential method, a display period for one screen (one frame period) is generally divided into three sub-frame periods. That is, a red image in accordance with a red component of an input signal is displayed in a first sub-frame period, a green image in accordance with a green component is displayed in a second sub-frame period, and a blue image in accordance with a blue component is displayed in a third sub-frame period, by which a color image is displayed in a liquid crystal panel.

Typically, since one frame period is 1/60 seconds, each of the above-mentioned three sub-frame periods is 1/180 second. Accordingly, a refresh rate indicating a rewriting speed of an entire screen displayed in the liquid crystal panel is 180 Hz.

Moreover, as the liquid crystal display device that adopts the field sequential method, there is one in which one frame period is divided into four or five sub-frame periods. In addition to red, green, and blue, at least one of yellow (Y), white (W), cyan (C), and magenta (M) is often assigned to one of these sub-frame periods. The refresh rate in the case of the four sub-frame periods is 240 Hz, and the refresh rate in the case of the five sub-frame periods is 300 Hz.

For example, in Japanese Patent Application Laid-Open No. 2001-331142, there has been described a configuration of an image display device that performs conversion to a pulse width modulation signal for each bit of gradation data to drive a display element in a bit-by-bit time division manner when time division action is performed. According to this configuration, since an existing pulse width modulation (PWM) circuit can be used, manufacturing costs of the device can be reduced without making the circuit large-scale.

### PRIOR ART DOCUMENT

### Patent Document

[Patent Document 1] Japanese Patent Application Laid-Open No. 2001-331142

### SUMMARY OF THE INVENTION

### Problems to be Solved by the Invention

Here, in the above-described Japanese Patent Application Laid-Open No. 2001-331142, since a configuration in which a total of 24-bit data with each of R, G, and B of 8 bits is transferred is employed, for performing display in the liquid crystal display device adopting the field sequential method with this configuration, high-speed data transfer for implementing a very high refresh rate is required.

Furthermore, it has been known that in the liquid crystal display device that adopts the field sequential method, when the three colors of RGB are displayed continuously, so-called color breakup is caused by characteristics of eyeball movement, optic nerve and the like. For countermeasures of this color breakup, in the liquid crystal display device that adopts the field sequential method, a plurality of colors such as white, yellow and the like are often added to the display colors lest the above-mentioned RGB should be continuously displayed. However, increasing the display colors in this manner disadvantageously makes the very high refresh rate further higher. Specifically, if the display colors are increased to four colors or to five colors, the refresh rate becomes 240 Hz or 300 Hz, which is four times or five times as high as 60 Hz as the refresh rate of a general display device.

There is no choice but to use a special interface in order to perform the high-speed data transfer for implementing the above-described very high refresh rate. This, however, largely increases the manufacturing costs of the device. Moreover, in the case where an interface based on a well-known standard, for example, an HDMI (High-Definition Multimedia Interface) (HDMI is a registered trademark) is used, a number of connection cables need to be provided. However, in this case as well, the manufacturing costs rise, and since a number of cables need to be connected, downsizing of the device is difficult, and assembling takes labor.

Consequently, an object of the present invention is to provide a liquid crystal display device adopting a field sequential method that can suppress increase in a number of transmission signal lines such as cables and the like, while using an interface based on an existing standard.

### Means for Solving the Problems

A first aspect of the present invention is directed to a display device that divides one frame period into a plurality of sub-frame periods to display an image in a predetermined color in each of the sub-frame periods, the display device including:

a display panel including a plurality of pixel formation portions arranged in matrix;

a display control circuit that outputs a video signal to control transmittance of light of the plurality of pixel formation portions in each of the sub-frame periods, based on a digital input signal; and

a plurality of drive circuits that drive the plurality of pixel formation portions based on the video signal, wherein

the plurality of drive circuits drive the plurality of pixel formation portions in parallel, the plurality of pixel formation portions corresponding to a plurality of regions resulting from dividing the display panel into a plurality of portions,

the display control circuit includes:
a signal processing circuit that outputs a plurality of display gradation data groups in parallel based on the digital input signal, the plurality of display gradation data groups corresponding to the plurality of regions; and
a plurality of timing control circuits that are each provided to control each of the plurality of drive circuits, and each receive the display gradation data groups of the corresponding region from the signal processing circuit through a predetermined transmission signal line, and

the transmission signal line is a signal line that can transmit the display gradation data groups in parallel through a predetermined number of transmission paths, the predetermined number being three or more, and transmits the display gradation data groups of a same color in parallel through transmission paths the number of which is not greater than the predetermined number.

According to a second aspect of the present invention, in the first aspect of the present invention,

the transmission signal line is a cable for a predetermined standard for transmitting the digital input signal, and the timing control circuit and the signal processing circuit are connected by only the one transmission signal line.

According to a third aspect of the present invention, in the second aspect of the present invention,

the standard is an HDMI standard.

According to a fourth aspect of the present invention, in the first aspect of the present invention,

the signal processing circuit allows the transmission signal line to transmit the display gradation data groups of the same color in parallel through transmission paths the number of which is a number obtained by subtracting one from the predetermined number.

According to a fifth aspect of the present invention, in the fourth aspect of the present invention,

the signal processing circuit allows the transmission signal line to transmit data of zero or a value decided beforehand corresponding to one of the display gradation data groups, and the display gradation data groups of the same color, in parallel.

According to a sixth aspect of the present invention, in the first aspect of the present invention,

the signal processing circuit generates the display gradation data groups of a gradation bit number q (q is a natural number) larger than a gradation bit number p (p is a natural number) of the display gradation data groups that can be transmitted in parallel by the transmission signal line, and allows the transmission signal line to transmit a part of the display gradation data groups including only the transmittable p bits of the generated display gradation data groups, and data including all data of the remaining (q−p) bits, which corresponds to the display gradation data groups, in parallel.

According to a seventh aspect of the present invention, in the first aspect of the present invention,

the signal processing circuit allows the transmission signal line to transmit a plurality of display gradation data groups corresponding to one row to be simultaneously displayed in the region, in arrangement order in which pixel gradation data to be given to the pixel formation portion located at a distance of half the row along the row is transmitted continuously.

An eighth aspect of the present invention is directed to a display method in which one frame period is divided into a plurality of sub-frame periods to display an image in a predetermined color in each of the sub-frame periods in a display panel including a plurality of pixel formation portions arranged in matrix, the display method including:

a display control step of outputting a video signal to control transmittance of light of the plurality of pixel formation portions in each of the sub-frame periods, based on a digital input signal; and

a plurality of drive steps of driving the plurality of pixel formation portions based on the video signal, wherein

in the plurality of drive steps, the plurality of pixel formation portions corresponding to a plurality of regions resulting from dividing the display panel into a plurality of portions are driven in parallel,

the display control step comprising:
a signal processing step of outputting a plurality of display gradation data groups in parallel based on the digital input signal, the plurality of display gradation data groups corresponding to the plurality of regions; and
a plurality of timing control steps that are each provided to control each of the plurality of driving steps, and each receive the display gradation data groups of the corresponding region from the signal processing step through a predetermined transmission signal line, and

the transmission signal line is a signal line that can transmit the display gradation data groups in parallel through a predetermined number of transmission paths, the predetermined number being three or more, and transmits the display gradation data groups of a same color in parallel through transmission paths the number of which is not greater than the predetermined number.

### Effects of the Invention

According to the first aspect of the present invention, the transmission signal line is a signal line that can transmit the display gradation data in parallel through the predetermined number (typically three where RGB are separately transmitted) of transmission paths, and transmits the display gradation data groups of the same color in parallel through transmission paths the number of which is not greater than the predetermined number, which can suppress the increase in number of the transmission signal lines such as the cables and the like.

According to the second aspect of the present invention, the transmission signal line is the cable for the predetermined standard, and the timing control circuit and the signal processing circuit are connected by only the one transmission signal line. Accordingly, the cables and an interface circuit for connecting the cables can be made fewer, which can reduce manufacturing costs. Moreover, since connection work between substrates becomes easy, a number of assembling process can be made small, and operational errors can be reduced.

According to the third aspect of the present invention, using the HDMI cable on the market lowers a cost of the cable, and stable signal transmission can be implemented.

According to the fourth aspect of the present invention, since the signal processing circuit allows the transmission signal line to transmit the display gradation data groups of the same color in parallel through the fewer transmission paths, arrangement processing such as rearrangement of the data and the like can be made simple.

According to the fifth aspect of the present invention, since received zero or the received predetermined value can be discarded by the signal processing circuit, the arrangement processing such as the rearrangement of the data and the like can be made simple.

According to the sixth aspect of the present invention, the display gradation data groups of a large bit number, for example, 10 bits can be transmitted in parallel by using a transmission signal line for a small bit number, for example, a transmission signal line for 8-bit transmission, which normally cannot transmit the display gradation data groups of 10 bits.

According to the seventh aspect of the present invention, since the charging time difference to the pixel capacitances caused inside the display region can be averaged, high-quality display without luminance unevenness can be implemented.

According to the eighth aspect of the present invention, an effect similar to the effect in the first aspect of the present invention can be exerted.

### BRIEF DESCRIPTION OF THE DRAWINGS

FIG. 1 is a block diagram showing a configuration of a liquid crystal display device that adopts a field sequential method according to a first embodiment of the present invention.

FIG. 2 is a diagram showing a configuration of a digital signal transmitted through HDMI cables in the above-mentioned embodiment.

FIG. 3 is a diagram showing a configuration of a digital signal transmitted through HDMI cables in a second embodiment of the present invention.

FIG. 4 is a block diagram showing an essential part of a configuration of a liquid crystal display device that adopts a field sequential method according to a third embodiment of the present invention.

FIG. 5 is a diagram showing a configuration of a digital signal transmitted through HDMI cables in the above-mentioned embodiment.

FIG. 6 is a diagram showing a configuration of a digital signal transmitted through HDMI cables in a fourth embodiment of the present invention.

### MODES FOR CARRYING OUT THE INVENTION

### 1. First Embodiment

### 1.1 Configuration of Liquid Crystal Display Device

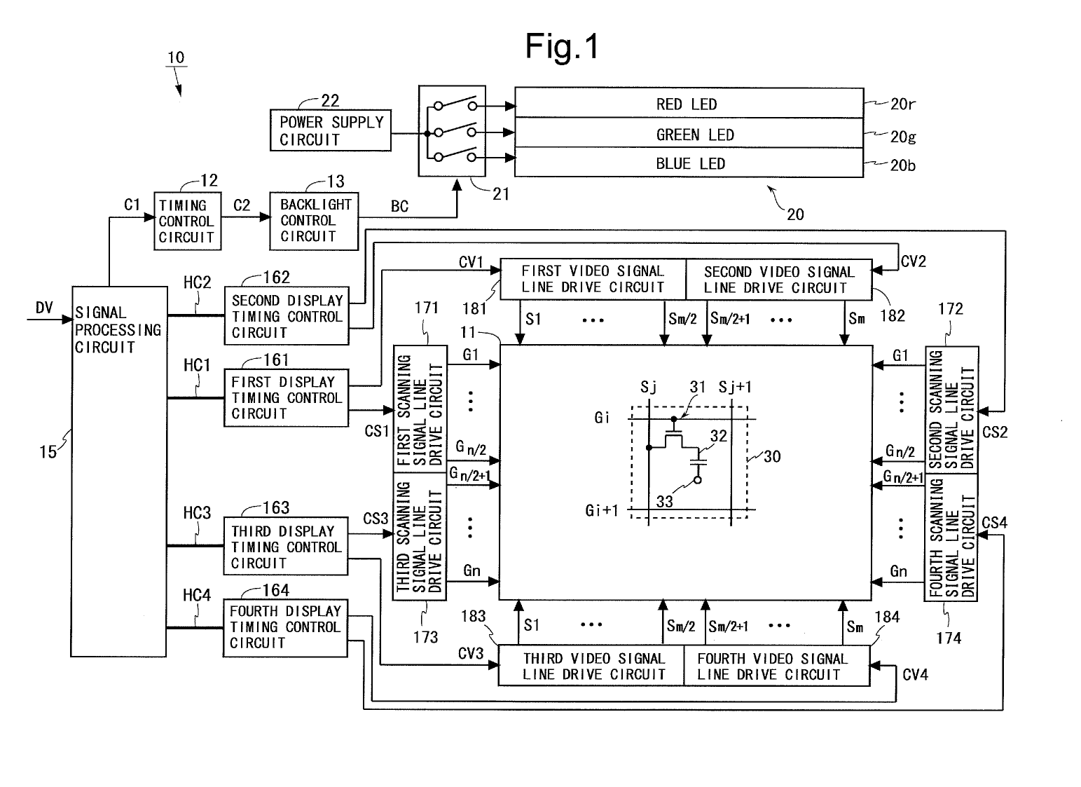

FIG. 1 is a block diagram showing a configuration of a liquid crystal display device 10 that adopts a field sequential method according to a first embodiment of the present invention. The liquid crystal display device 10 shown in FIG. 1 performs color display by a field sequential color method in which one frame period is divided into five sub-frame periods. The liquid crystal display device 10 includes a liquid crystal panel 11, a timing control circuit 12, a backlight control circuit 13, a signal processing circuit 15, first to fourth display timing control circuits 161 to 164, first to fourth scanning signal line drive circuits 171 to 174, first to fourth video signal line drive circuits 181 to 184, a backlight unit 20, a switch group 21, and a power supply circuit 22. It should be noted that the first to fourth scanning signal line drive circuits 171 to 174, and the first to fourth video signal line drive circuits 181 to 184 may be simply referred to as drive circuits collectively in the following description.

Moreover, in this case, the signal processing circuit 15; and the liquid crystal panel 11, the drive circuits thereof, and the first to fourth display timing control circuits 161 to 164; and the timing control circuit 12, the backlight control circuit 13, the backlight unit 20, and the switch group 21; and the power supply circuit 22 are provided in different substrates. However, these are not necessarily provided in the different substrates, but a part or all of them may be provided in the same substrate, or may be provided in further different substrates.

In the present embodiment, the signal processing circuit 15 and the first to fourth display timing control circuits 161 to 164 are connected by corresponding first to fourth HDMI cables HC1 to HC4, and this is a feature. It should be noted that these cables may be each a well-known signal line employing a well-known standard other than an HDMI standard, or another transmission method. However, as described later, these cables are preferably signal lines that can transmit display gradation data for displaying an image having colors of a predetermined number not smaller than three through the relevant predetermined number of transmission paths in parallel, and can transmit the display gradation data of the same color in parallel.

Although in the following description, one frame period is 1/60 second, and each of the sub-frame periods is 1/300 second, the length is not particularly limited, as long as it is a well-known display period. Moreover, it is assumed that a red component (a red gradation value), a green component (a green gradation value), and a blue component (a blue gradation value) of an input signal externally inputted to the liquid crystal display device 10 are each 8-bit data. A bit number for representing the gradation value is hereinafter referred to as a gradation bit number. The gradation bit number here is 8.

The liquid crystal panel 11 includes a plurality of (m) video signal lines S1 to Sm, a plurality of (n) scanning signal lines G1 to Gn, and a plurality of (m×n) pixel formation portions 30 provided corresponding to intersections between the plurality of video signal lines S1 to Sm and the plurality of scanning signal lines G1 to Gn. In this case, it is assumed that full HD display is performed. Accordingly, m is 1920 and n is 1080.

Each of the pixel formation portions 30 includes a TFT 31 functioning as a switching element, a pixel electrode 32 connected to the TFT 31, and a common electrode 33 forming a liquid crystal capacitance together with the pixel electrode 32. A gate terminal of the TFT 31 is connected to a scanning signal line Gi (1≦i≦n), and a source terminal thereof is connected to a video signal line Sj (1≦j≦m).

An input signal DV, which is a digital signal, is externally inputted to the signal processing circuit 15. The signal processing circuit 15 outputs a control signal C2 for controlling the timing control circuit 12. The timing control circuit 12 generates a control signal C2 based on the control signal C1 so that timing when red, green, and blue LEDs (Light Emitting Diodes) 20r, 20g, 20b included in the backlight unit 20 are caused to emit, and timing when video signal line drive circuits 18 output red, green, blue, yellow and white drive image signals to the video signal lines S1 to Sm coincides with each other. The timing control circuit 12 gives the control signal C2 to the backlight control circuit 13.

Based on the input signal DV representing the respective red (R), green (G), and blue (B) gradation values, the signal processing circuit 15 adds respective yellow (Y) and white (w) gradation values to generate gradation value data of a total of five types of colors, that is, the yellow and white gradation values and further respective corrected red, green, and blue gradation values. It should be noted that yellow (Y) and white (W) here are illustrative, and any well-known color may be employed. The method for calculating a display gradation value of a pixel consisting of the five display colors (RGBYW) from an input gradation value of a pixel consisting of the three primary colors (RGB) in this manner is well-known, and for example, a gradation value consisting of the five display colors (RGBYW) is generated based on predetermined color distribution algorism from a gradation value consisting of the three primary colors (RGB). This color distribution algorism may be any well-known algorism. For example, only a predetermined amount of achromatic component, i.e., white (W) is extracted in view of color balance of the respective colors, gamma characteristics and the like across an entire screen, and a gradation value consisting of the remaining four display colors (RGBY) is decided so as to obtain an equal distribution ratio, based on the respective gradation values (RGB) resulting from removing the relevant achromatic component. The respective gradation values decided in this manner are temporarily stored in an external memory or a built-in memory not shown.

Next, the signal processing circuit 15 arranges (rearranges) the gradation values stored in the memory as needed to generate a digital signal suitable for the field sequential method. That is, in the field sequential method, since a number of the colors displayed in one sub-frame period is only one, the gradation value to be transmitted in the relevant sub-frame period is to display only the relevant color. A content of such a digital signal (the arrangement of the data) will be described later.

The first display timing control circuit 161 drives the first scanning signal line drive circuit 171 and the first video signal line drive circuit 181, based on the digital signal transmitted through the first HDMI cable HC1. Specifically, the first display timing control circuit 161 gives a control signal (e.g., a gate clock signal or the like) CS1 to the first scanning signal line drive circuit 171, and a control signal (e.g., a source clock signal or the like) CV1 to the first video signal line drive circuit 181 to thereby control them. It should be noted that the first display timing control circuit 161 again rearranges the gradation data in the predetermined arrangement order suitable for the field sequential method, which is received from the signal processing circuit 15 through parallel transmission, to normal arrangement order suitable for being given to the first video signal line drive circuit 181 (i.e., to arrangement order of the pixel). Such a rearrangement can be easily performed through the use of a well-known memory, register or the like.

The first scanning signal line drive circuit 171 sequentially outputs an active scanning signal to the respective scanning signal lines G1 to Gn/2, based on the control signal CS1. The first video signal line drive circuit 181 generates drive image signals based on the control signal CV1 including video signals, and outputs the drive image signals to the respective video signal lines S1 to Sm/2 at timing decided by the control signal CV1. The drive image signals outputted to the video signal lines S1 to Sm/2 are given to the pixel capacitances through the TFTs 31 connected to the scanning signal lines G1 to Gn/2 which are sequentially activated. Thereby, voltages in accordance with the drive image signals are applied to a liquid crystal, and transmittance of the liquid crystal changes in accordance with the applied voltage, which allows an image to be displayed in the liquid crystal panel 11. That is, the first display timing control circuit 161, the first scanning signal line drive circuit 171 and the first video signal line drive circuit 181 perform display in a region in an upper left portion when the liquid crystal panel 11 is divided into four vertically and horizontally. It should be noted that, in light of operating speeds, manufacturing costs and the like of the scanning signal line drive circuit and the video signal line drive circuit, a size of the display region driven by these circuits is preferably about ¼ of the whole display region of the full HD (1920×1080), and the above-described configuration (and a configuration in each embodiment described later) conforms to the foregoing.

However, in the present embodiment, since the first and third scanning signal line drive circuits 171, 173, and the second and fourth scanning signal line drive circuits 172, 174 simultaneously select the different scanning signal lines, a number of the scanning signal lines to be selected by the one scanning signal line drive circuit in one sub-frame period can be made half the number of the scanning signal lines in a normal case. Accordingly, a drive frequency of the drive circuit can be lowered, which can decrease the manufacturing costs thereof.

Operation of the second display timing control circuit 162 is similar to that of the above-described first display timing control circuit 161, and the second display timing control circuit 162 drives the second scanning signal line drive circuit 172 and the second video signal line drive circuit 182 based on the digital signal transmitted through the second HDMI cable HC2. Furthermore, the third or fourth display timing control circuit 163, 1641 is similar, and drives the third or fourth scanning signal line drive circuit 173, 174, and the third or fourth video signal line drive circuit 183 or 184, based on the digital signal transmitted through the third or fourth HDMI cable HC3, HC4.

In this manner, the first to fourth display timing control circuits 161 to 164, the first to fourth scanning signal line drive circuits 171 to 174, and the first to fourth video signal line drive circuits 181 to 184 perform the display in parallel in the corresponding regions when the liquid crystal panel 11 is divided into four vertically and horizontally. That is, the first and second scanning signal line drive circuits 171, 172 simultaneously select the scanning signal lines passing the corresponding region sequentially from above in the same manner, and at timing synchronous with this, the third and fourth scanning signal line drive circuits 173, 174 also simultaneously select the scanning signal lines passing the corresponding region sequentially from above in the same manner. It should be noted that, in order to implement such a display, the video signal lines S1 to Sm are cut at centers thereof. Furthermore, central portions of the scanning signal lines G1 to Gn may be similarly cut.

The backlight unit 20 includes the red LED (Light Emitting Diode) 20r, the green LED 20g, and the blue LED 20b arranged two-dimensionally. The red LED 20r, the green LED 20g, and the blue LED 20b are connected independently of one another to the power supply circuit 22 through the switch group 21. The backlight control circuit 13 generates a backlight control signal BC for turning on each switch (putting it into a conductive state) included in the switch group 21 in the sub-frame period as needed, based on the control signal C2 given from the timing control circuit 12, and gives the backlight control signal BC to the switch group 21.

The switch group 21 connects one or more of the red LED 20r, the green LED 20g, and the blue LED 20b to the power supply circuit 22 at proper timing to give a power supply voltage, based on the backlight control signal BC. Thereby, one or more of the red LED 20r, the green LED 20g, and the blue LED 20b emit light at the timing when the drive image signals are applied to the video signal lines S1 to Sm to irradiate one or more types of red, green and blue light from a back surface of the liquid crystal panel 11 in a predetermined sub-frame period (strictly speaking, in a latter half of the period). For example, when the red light and the green light are irradiated, mixing the relevant colors produces yellow as the display color, and when the red light, the green light, and the blue light are irradiated, mixing the relevant colors produces white as the display color.

It should be noted that a yellow LED may be newly provided to display the yellow color, and a white LED may be newly provided to display the white color. Moreover, as light sources included in the backlight unit 20, in place of the red, green and blue LEDs 20r, 20g, 20b, well-known light sources such as red, green, and blue CCFLs (Cold Cathode Fluorescent Lamps) and the like may be used.

In the liquid crystal display device 10 in the present embodiment, one frame period is divided into first to fifth sub-frame periods, and the display colors assigned to the respective sub-frame periods are displayed, for example, in order of RWGYB. According to the present invention, as the arrangement order of these display colors, any well-known order may be employed.

For example, in a first half of the first sub-frame period, each of the pixel formation portions 30 is driven by the drive image signal generated based on the gradation value indicating the red color included in the control signals CV1 to CV4 outputted from the first to fourth display timing control circuits 161 to 164, and in a latter half thereof, the red LED 20r emits light. Similarly, in a first half of each of the second to fifth sub-frame periods, each of the pixel formation portions 30 is driven by the drive image signal generated based on the gradation values indicating the colors included in the control signals CV1 to CV4, and in a latter half thereof, the LEDs 20 of the corresponding colors emit light.

As described above, since in the screen of the liquid crystal panel 11, operation of displaying the pixels in the predetermined color with brightness in accordance with the gradation value is performed sequentially for a short time, the liquid crystal display device 10 can display the color image, utilizing time persistence of vision.

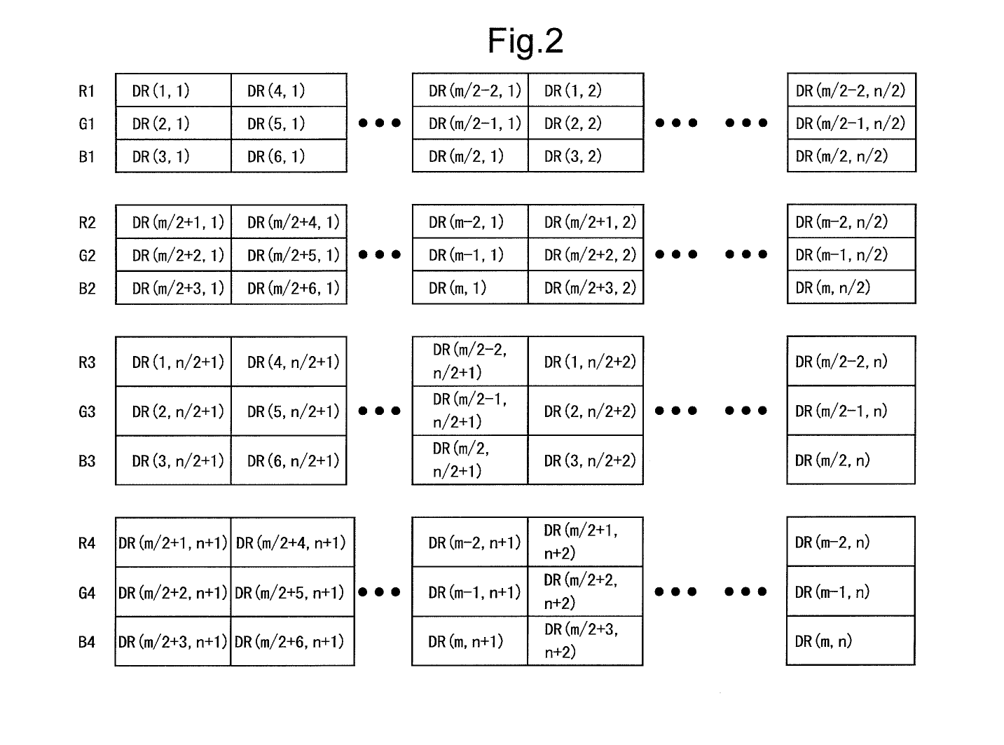

Next, a configuration of the digital signal given from the signal processing circuit 15 to the first display timing control circuit 161 through the first HDMI cable HC1, which is a characteristic configuration of the present embodiment, will be described with reference to FIG. 2.

### 1.2 Configuration of Digital Signal Transmitted Through HDMI Cable

FIG. 2 is a diagram showing the configuration of the digital signal transmitted through the HDMI cable. A row given characters R1 on a left side of the figure denotes a transmission path for R data inside the first HDMI cable HC1, and specifically, a transmission path in which 8-bit data indicating a red gradation value in a general digital video signal is to be transmitted. A character B1 or G1 also denotes a transmission path for B data or a transmission path for G data, respectively, inside the first HDMI cable HC1 similarly. Moreover, characters R2, G2, B2 also denote transmission paths for R data, G data, and B data, respectively, inside the second HDMI cable HC2. Still moreover, R3, G3, B3, R4, G4, B4 are also similar.

It should be noted that, in each of the HDMI cables, these transmission paths for the R data and the like are each realized by a pair of signal lines (and clock lines) based on a differential signal transmission method, that is, are realized by a total of three pairs of signal lines. Moreover, a lateral direction in the figure corresponds to a time axis, and in the figure, the data transmitted in the first sub-frame period is indicated.

Moreover, DR (q, p) (where q is a natural number not larger than m, and p is a natural number not larger than n) denotes drive video signal data indicating the red gradation value given to a pixel formation portion P (q, p) selected by a scanning signal line Gp and a video signal line Sq. It should be noted that, when the red color is displayed, the red LED 20r is lighted, as described before.

As can be understood with reference to FIG. 2, not only through the transmission path for the R1 data inside the first HDMI cable HC1 (the row given R1 in the figure), but through the transmission path for the G data (the row given G1 in the figure) and the transmission path for the B data (the row given B1 in the figure), the drive video signal data indicating the red gradation value is transmitted. This corresponds to the fact that only the red color is displayed in the first sub-frame period, and this is a characteristic configuration in which three pieces of display gradation data of the same color (data for three pixels) are transmitted in parallel in the HDMI cable that can transmit three pieces of display gradation data (RGB) for displaying the RGB image in parallel.

In this manner, in the first sub-frame period, the data to be given to the first display timing control circuit 161, that is, DR (1, 1) to DR(m/2, n/2), which are the data used by the first scanning signal line drive circuit 171 and the first video signal line drive circuit 181 for the display in the region in the upper left portion of the liquid crystal panel 11, are transmitted by using only one of the HDMI cables, that is, the first HDMI cable HC1.

This is true of the data given to the second to fourth display timing control circuits 162 from the signal processing circuit 15, and the above-described data is transmitted by using only relevant one of the second to fourth HDMI cables HC2 to HC4.

Generally, based on a standard of the HDMI 1.3, a maximum transmission speed of data that can be transmitted through one HDMI cable is about 10.3 Gbps, while a transmission speed of a base band signal in one pair of signal lines (a transmission path for transmitting any of EGB) in the HDMI cable is about 3.4 Gbps. It should be noted that, based on a standard of HDMI 1.2, the transmission speed is decreased to about half of this.

On the other hand, in the case where a frame rate is 60 Hz, and full HD display is performed by the field sequential drive using five sub-frame periods, a required data transmission speed is about 4.98 Gbps (=1920×1080×300 (Hz)×8 (gradation bits)). Since this required transmission speed exceeds the maximum data transmission speed 3.4 Gbps of the pair of signal lines in the HDMI cable based on the HDMI 1.3 standard, the transmission by a general transmission method set in the HDMI standard cannot be performed.

Accordingly, in the present embodiment, the data of one color is transmitted, using the transmission paths for the RGB data in the one HDMI cable. It should be noted that a data transmission speed through the HDMI cable in the present embodiment is about 1.24 Gbps (=1920×1080×¼×300 (Hz)×8 (gradation bits)), and not only the cable based on the standard of the HDMI 1.3 but the cable based on the standard of the HDMI 1.2 can be used. Moreover, while when the display gradation is 24 bits, the above-described data amount becomes three times, even in this case, the configuration of the present embodiment in which only one of the HDMI cables is used can be applied.

### 1.3 Effects of First Embodiment

As described above, according to the liquid crystal display device 10 in the present embodiment, since the gradation data is rearranged to the data arrangement as shown in FIG. 2 suitable for the field sequential drive in the signal processing circuit 15, and the gradation data of the corresponding display regions is transmitted to the first to fourth display timing control circuits 161 to 164, the number of the HDMI cables for each transmission is enabled to be one. This makes the cables and the interface circuit for connecting the cables fewer, thereby reducing the manufacturing costs. Moreover, since connection work between the substrates becomes easy, a number of assembling processes can be made smaller, and operational errors can be reduced. Furthermore, using HDMI cables on the market lowers a cost of the cables, and stable signal transmission can be implemented.

### 2. Second Embodiment

### 2.1 Configuration of Liquid Crystal Display Device

An entire configuration of a liquid crystal display device that adopts a field sequential method according to a second embodiment of the present invention is similar to the case in the first embodiment (refer to FIG. 1), and the liquid crystal display device performs similar operation except that one frame period is divided into four sub-frame periods, and thus, description thereof will be omitted.

As to the liquid crystal display device in the present embodiment, operation of the signal processing circuit 15 is partially different from the case of the first embodiment in that the four sub-frame periods are used. That is, based on an input signal DV representing respective red (R), green (G), and blue (B) gradation values, the signal processing circuit 15 adds, for example, only a white (W) gradation value to generate gradation values of a total of four types of colors, that is, the white gradation value and further corrected red, green, and blue gradation values. It should be noted that, since a method for calculating the display gradation value of a pixel consisting of the four display colors (RGBW) from the input gradation value of the pixel consisting of three primary colors (RGB) is well-known as in the first embodiment, and description thereof will be omitted.

As to the liquid crystal display device 10 in the present embodiment, one frame period is divided into first to fourth sub-frame periods, and the display colors assigned to the respective sub-frame periods are displayed in order of RGBW. It should be noted that this order may be any well-known order. Since one sub-frame period is 1/240 second and a refresh rate is 240 Hz by such a configuration, a speed of data transmission can be lowered, as compared with the case of the drive at 300 Hz, which is the refresh rate in the first embodiment.

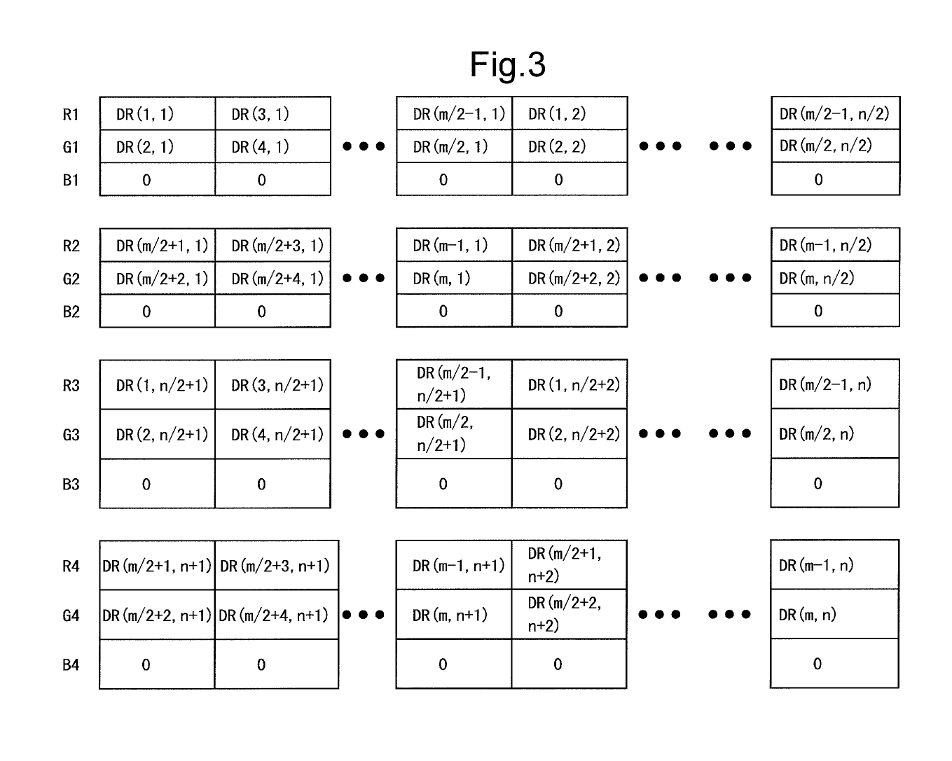

However, in the present embodiment, unlike the case of the first embodiment, a transmission path for R data and a transmission path for G data inside the first HDMI cable HC1 are used, while a transmission path for B data is not used by inserting zero. Hereinafter, referring to FIG. 3, a configuration of a digital signal transmitted through the HDMI cables in the present embodiment will be described.

### 2.2 Configuration of Digital Signal Transmitted Through HDMI Cable

FIG. 3 is a diagram showing the configuration of the digital signal transmitted through the HDMI cables. As in FIG. 2, rows given characters R1, G1, B1 on a left side of the figure denote the transmission paths for the R data, the G data, and the B data inside the first HDMI cable HC1, respectively. Other representation methods are similar to those in FIG. 2, and thus, description here will be omitted.

As can be understood with reference to FIG. 3, only through the transmission path for the R data inside the first HDMI cable HC1 (which is the row given R1 in the figure), and through the transmission path for the G data (which is the row given G1 in the figure), drive video signal data indicating the red gradation value is transmitted, while through the transmission path for the B data (which is the row given B1 in the figure), a value of zero is transmitted. This corresponds to the fact that only the red color is displayed in the first sub-frame period as in the first embodiment. However, unlike the case of the first embodiment, in the HDMI cable that can transmit three pieces of display gradation data for displaying an image of the three colors of RGB in parallel, only two pieces of display gradation data of the same color (data for two pixels) are transmitted in parallel, and the value of zero corresponding to the display gradation value is transmitted through the remaining transmission path (in this case, the B data transmission path), which is a characteristic configuration.

In this manner, in the first sub-frame period, the data to be given to the first display timing control circuit 161, that is, DR(1, 1) to DR(m/2, n/2), which are data used by the first scanning signal line drive circuit 171 and the first video signal line drive circuit 181 for display in a region in an upper left portion of the liquid crystal panel 11, are transmitted by using only one of the HDMI cables, that is, the first HDMI cable HC1. It should be noted that, while the first display timing control circuit 161 again rearranges the received data, the received data of zero is discarded.

The foregoing is true of data given to second to fourth display timing control circuits 162 to 164 from the signal processing circuit 15, and the above data is transmitted by using only relevant one of the second to fourth HDMI cables HC2 to HC4.

Here, in the present embodiment, since only the two pieces of gradation data (data for two pixels) need to be transmitted in parallel, data arrangement processing in the signal processing circuit 15 can be made simpler than the case where the three pieces of gradation data are transmitted. Accordingly, the data of zero is not necessarily transmitted through the remaining transmission path, and the configuration may be such that a fixed value decided beforehand is transmitted through the remaining transmission path. Moreover, the line where the data of zero or the like is transmitted may not be the transmission path for the B data, but may be replaced by a transmission path for other data.

It should be noted that, when one pair of signal lines (which is the data transmission path for any of RGB) in one of the HDMI cables in the present embodiment is focused on, a transmission speed of a base band signal in these signal lines is about 0.62 Gbps (=1920×1080×¼×300 (Hz)×8 (gradation bits)/2 (pairs)). This transmission speed is below about 3.4 Gbps, which is a maximum transmission speed of the one pair of signal lines in the cable based on the standard of the HDMI 1.3, and thus, the cable based on the standard of the HDMI 1.2 can also be used. Moreover, while when the display gradation is 24 bits, a data amount to be transmitted is three times as large as the foregoing, even in this case, the configuration of the present embodiment in which only one of the HDMI cables based on the standard of the HDMI 1.3 is used can also be applied.

It should be noted that, while the liquid crystal display device 10 in the present embodiment has been described on the assumption that a frame rate is 60 Hz as in the first embodiment, this may be 72 Hz in order to increase display quality. Even in this case, since the refresh rate is 288 Hz, the speed of the data transmission can be lowered, as compared with the case of the drive whose refresh rate is 300 Hz in the first embodiment.

### 2.3 Effects of Second Embodiment

As described above, according to the liquid crystal display device 10 in the present embodiment, since the gradation data is rearranged to the data arrangement as shown in FIG. 3 suitable for the field sequential drive in the signal processing circuit 15, and the gradation data of the corresponding display regions is transmitted to the first to fourth display timing control circuits 161 to 164, the number of the HDMI cables for each transmission is enabled to be one as in the first embodiment. This reduces the manufacturing costs, makes the number of assembling processes smaller, and implements the stable signal transmission. Moreover, since data arrangement processing in the signal processing circuit 15 can be made simple, the manufacturing costs can be decreased by lowering the required processing capacity of the signal processing circuit 15.

### 3. Third Embodiment

### 3.1 Configuration of Liquid Crystal Display Device

Since an entire configuration of a liquid crystal display device that adopts a field sequential method according to a third embodiment of the present invention is analogous to the case of the first embodiment, description of similar configuration elements will be omitted.

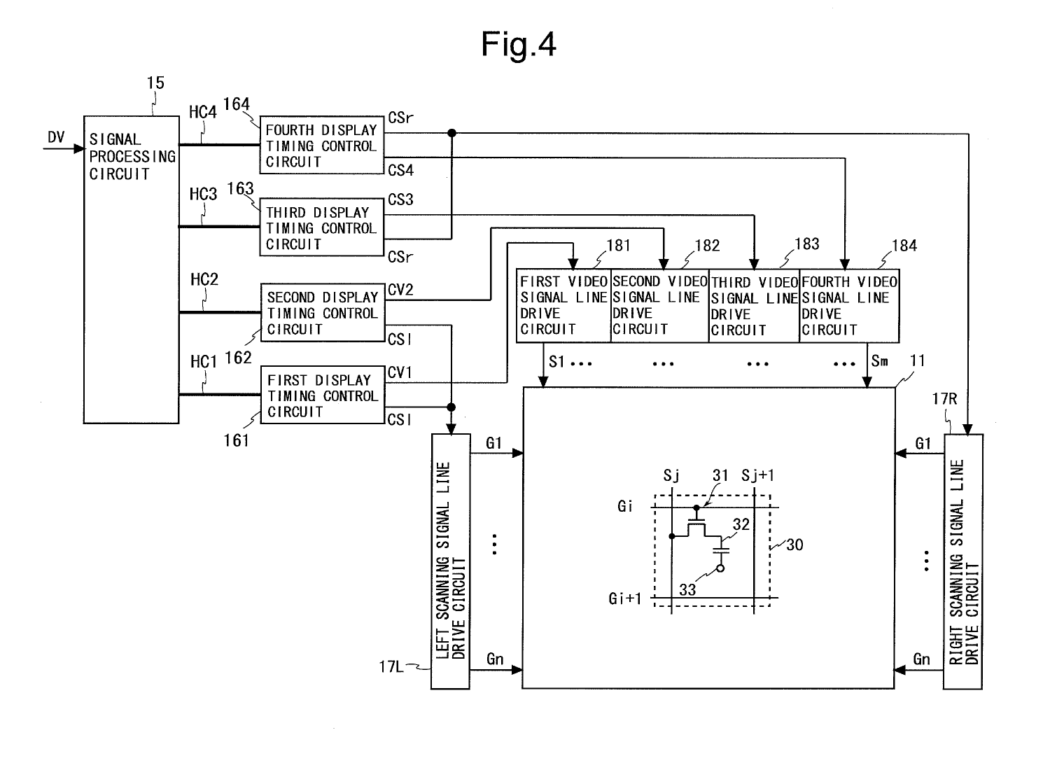

FIG. 4 is a block diagram showing a configuration of an essential part of the liquid crystal display device 10 that adopts the field sequential method according to the third embodiment of the present invention. In the liquid crystal display device 10 of the present embodiment, although one frame period is divided into five sub-frame periods to perform display similar to the liquid crystal display device 10 shown in FIG. 1, a left scanning signal line drive circuit 17L and a right scanning signal line drive circuit 17R are provided in place of the first to fourth scanning signal line drive circuits 171 to 174. Moreover, first to fourth video signal line drive circuits 181 to 184 are arranged in order only on an upper side, as shown in FIG. 4. Accordingly, a display region in the liquid crystal panel 11 is vertically divided into four in parallel, and for example, the left scanning signal line drive circuit 17L and the first video signal line drive circuit 181 perform display in a display region at a left end of the liquid crystal panel 11. It should be noted that the left scanning signal line drive circuit 17L and the right scanning signal line drive circuit 17R, and the first to fourth video signal line drive circuits 181 to 184 may be simply referred to as drive circuits collectively in the following description.

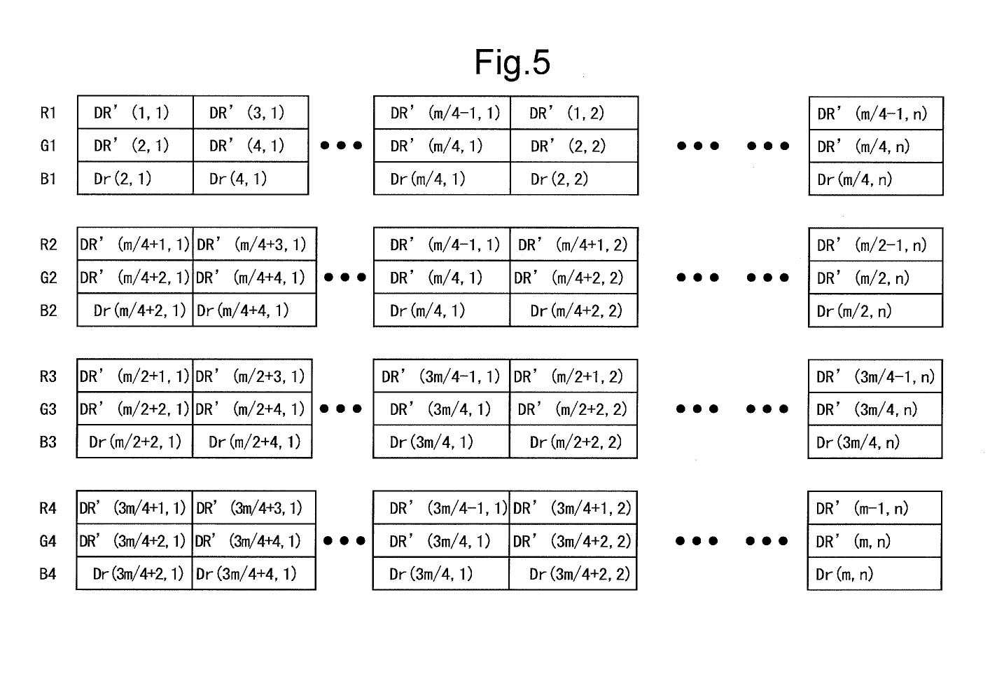

In the present embodiment, the configuration of the drive circuits and the corresponding display regions in the liquid crystal panel 11 are different from those of the first embodiment as described above, and is further different in that a gradation value used in the present embodiment is not 8 bits but 10 bits. Here, each of the gradation values of RGB is basically defined as 8 bits in the HDMI standard. Accordingly, a digital signal in the present embodiment transmitted through an HDMI cable has a characteristic configuration since a transmission path of 8 bits is used. So, a configuration of the digital signal given from the signal processing circuit 15 to the first display timing control circuit 161 through the first HDMI cable HC1 will be described with reference to FIG. 5.

### 3.2 Configuration of Digital Signal Transmitted Through HDMI Cable

FIG. 5 is a diagram showing the configuration of the digital signal transmitted through the HDMI cables. As in FIG. 2, rows given characters of R1, G1, B1 on a left side of the figure denote transmission paths for R data, G data, and B data, respectively, inside the first HDMI cable HC1.

DR′ (q, p) shown in this figure denotes data of a portion of low-order 8 bits of a gradation value 10 bits corresponding to DR (q, p). Moreover, Dr (q, p) denotes high-order 2 bits of a gradation value 10 bits corresponding to DR (q−1, p), and high-order 2 bits of the gradation value 10 bits corresponding to DR (q, p), as described later. Other representation methods are similar to the case of FIG. 2, and thus, description thereof will be omitted here.

As can be understood with reference to FIG. 5, through the transmission path for the R data inside the first HDMI cable HC1 (which is the row given R1 in the figure), and through the transmission path for the G data (which is the row given G1 in the figure), drive video signal data indicating the red gradation value is transmitted, this gradation value is the portion of the low-order 8 bits of the 10 bits. This is because the HDMI cable is designed so that the gradation data of 8 bits is transmitted in one pair of signal lines thereof. Accordingly, in order to transmit a gradation value of the remaining 2 bit, the transmission path for the B data inside the first HDMI cable HC1 (which is a row given B1 in the figure) is used. That is, through this transmission path, the data Dr (q, p) of a total of 4 bits obtained by combining the high-order 2 bits of the gradation value 10 bits corresponding to DR (q−1, p) and the high-order 2 bits of the gradation value 10 bits corresponding to DR (q, p) is transmitted.

In this manner, in the HDMI cable that can transmit three pieces of display gradation data for displaying an image of three colors of RGB in parallel, the data of the low-order 8 bits of a certain display gradation data for two pixels is transmitted in parallel, and the data of a total of 4 bits including the data of the high-order 2 bits of the display gradation data for two pixels is transmitted in the remaining transmission path, which is a characteristic configuration. It should be noted that, although the configuration is such that the data Dr(q, p) of 4 bits is transmitted through the data transmission path for the B data in this case, the data transmission for the B data may be replaced by another data transmission path.

As described above, in the first sub-frame period, the data to be given to the first display timing control circuit 161, that is, DR (1, 1) to DR(m/4, n), which are the data used by the left scanning signal line drive circuit 171 and the first video signal line drive circuit 181 for display in the region in the left end portion of the liquid crystal panel 11, can be transmitted by using only one of the HDMI cables, that is, the first HDMI cable HC1. The first display timing control circuit 161 again rearranges the received data. The first display timing control circuit 161 takes out the high-order 2 bits from the data Dr(q, p) of 4 bits of the received data at that time and combines them with the corresponding low-order 8 bits to restore the gradation data of 10 bits.

The foregoing is true of data given to the second to fourth display timing control circuits 162 to 164 from the signal processing circuit 15, and the above data can be transmitted by using only relevant one of the second to fourth HDMI cables HC2 to HC4.

A transmission speed in one of the HDMI cables in the present embodiment is about 1.56 Gbps (=1920×1080×¼×300 (Hz)×10 (gradation bits)), and not only the cable based on the standard of the HDMI 1.3 but the cable based on the standard of the HDMI 1.2 can be used.

### 3.3 Effects of Third Embodiment

As described above, according to the liquid crystal display device 10 in the present embodiment, since the gradation data is divided (into the low-order 8 bits and the high-order 2 bits), and assigned to the data arrangement as shown in FIG. 5 suitable for the field sequential drive in the signal processing circuit 15, and the gradation data in the corresponding display regions is transmitted to the first to fourth display timing control circuits 161 to 164, the number of the HDMI cables for each transmission is enabled to be one as in the first embodiment. This can reduce the manufacturing costs, and make the number of assembling processes smaller, and implement the stable signal transmission. Moreover, since the display gradation data of 10-bit gradation can be transmitted by the HDMI cable using the transmission paths for 8-bit gradation, an HDMI interface can be a general circuit, which can decrease the manufacturing costs.

### 4. Fourth Embodiment

### 4.1 Configuration of Liquid Crystal Display Device

An entire configuration of a liquid crystal display device that adopts a field sequential method according to a fourth embodiment of the present invention is similar to the case of the third embodiment (refer to FIG. 4), and similar operation to that of the third embodiment is performed except that arrangement order of display gradation data is different. Thus, description of the similar configuration and operation will be omitted.

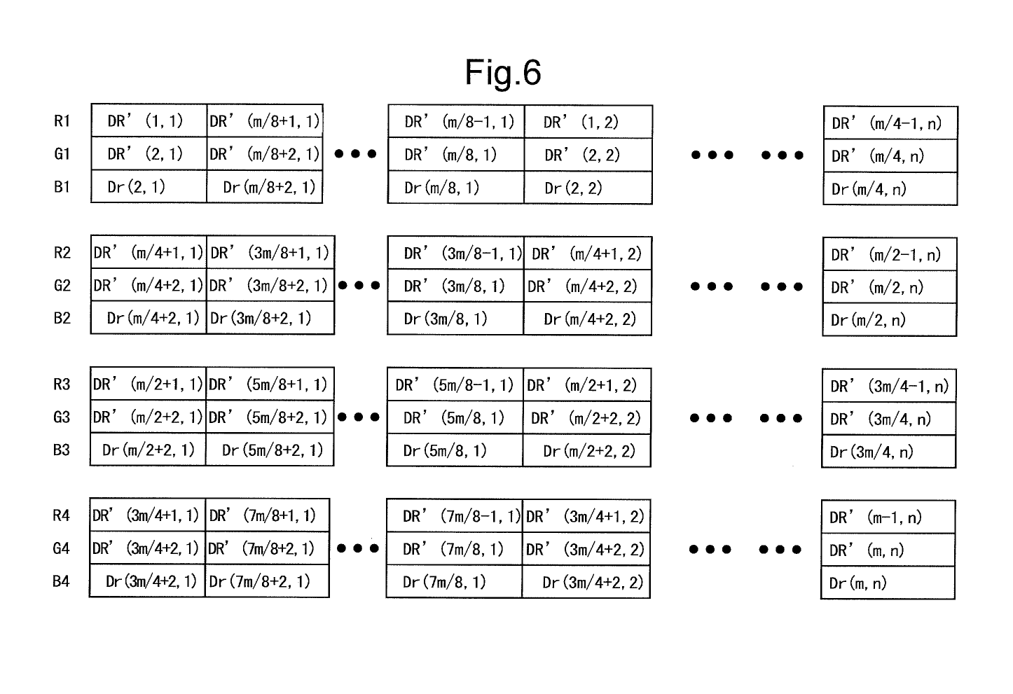

In the present embodiment, similar to the case of the third embodiment, a used gradation value is 10 bits. A digital signal in the present embodiment has a characteristic configuration since transmission paths of 8 bits are used, similar to the case of the third embodiment. A different point from the third embodiment is the arrangement order of the display gradation data, and thus, a configuration of the digital signal given to the first display timing control circuit 161 will be described with reference to FIG. 6.

### 4.2 Configuration of Digital Signal Transmitted Through HDMI Cable

FIG. 6 is a diagram showing the configuration of the digital signal transmitted through HDMI cables. As in FIG. 5, rows given characters R1, G1, B1 on a left side of the figure denote transmission paths for R data, G data, and B data inside the first HDMI cable HC1, respectively. Other representation methods are similar to those in FIG. 5, and thus, description here will be omitted.

As can be understood with reference to FIG. 6, in the respective transmission paths for the R data, the G data, and the B data inside the first HDMI cable HC1, gradation data transmitted first is completely the same as that shown in FIG. 5. However, in the present embodiment, the gradation data transmitted next is not gradation data to be given to a next adjacent pixel formation portion, but gradation data to be given to a pixel formation portion at a distance of m/8 in a right direction.

In a first sub-frame period, the data to be given to the first display timing control circuit 161, that is, DR (1, 1) to DR (m/4, n), which are data used by the left scanning signal line drive circuit 17L and the first video signal line drive circuit 181 for display in the display region in the left end portion of the liquid crystal panel 11, are not transmitted sequentially, as shown in FIG. 6. Gradation data to be given to a pixel formation portion located around a center is arranged as gradation data to be transmitted second so as to secure the distance of m/8, which is half a length in a direction along a row of the relevant display region (a lateral direction). Such an arrangement is repeated alternately. This arrangement makes inconspicuous a luminance difference due to a charging time difference to pixel capacitances, typically, at a left end portion and at a right end portion in the display region, which increases display quality. That is, in the present embodiment, since charging to the pixel capacitances is started at a left end side and at a central portion in the display region, the charging time difference to the pixel capacitances caused in the display region is surface-averaged, and as a result, display without luminance unevenness can be implemented.

### 4.3 Effects of Fourth Embodiment

As described above, according to the liquid crystal display device 10 in the present embodiment, in addition to obtaining the effects in the above-described embodiments, the high-quality display without luminance unevenness can be implemented since the charging time difference to the pixel capacitances caused inside the display region can be averaged.

### 5. Other Modifications

Although the liquid crystal display device has been described as an example in each of the above-described embodiments, liquid crystal is not necessarily used, as long as the display device uses a field sequential method. A configuration may be employed in which a well-known shutter element in place of liquid crystal is used. However, as in the liquid crystal, it is preferable for applying the present invention that the device has a response characteristic that gradation in a certain sub-frame period affects gradation in a next sub-frame period.

Although the configuration has been described as an example, in which the two or four scanning signal line drive circuits, and the four video signal line drive circuits are used, in each of the above-described embodiments, a number of these is not particularly limited. For example, a number of the video signal line drive circuits may be two, three, five or more. Moreover, while a number of the scanning signal line drive circuits may be three or more, a wiring relation with the video signal line drive circuits becomes complicated when the scanning signal line drive circuits are driven independently of one another, and thus, a configuration in which two are arranged on one side, or two are arranged on each of both sides is preferable.

Although the configuration is employed in which the four or five colors are used by adding yellow, while and the like to the three primary colors in each of the above-described embodiments, the present invention is not limited by the number of the colors, and types thereof. Other various modifications can be made to the above-described embodiments.

### INDUSTRIAL APPLICABILITY

The present invention is applied to a color display device, and is suitable for a display device such as, particularly, a liquid crystal display device that performs color display by a field sequential method, and the like.

### DESCRIPTION OF REFERENCE CHARACTERS

10: LIQUID CRYSTAL DISPLAY DEVICE
11: LIQUID CRYSTAL PANEL
13: BACKLIGHT CONTROL CIRCUIT
15: SIGNAL PROCESSING CIRCUIT
161 TO 164: FIRST TO FOURTH TIMING CONTROL CIRCUITS
171 TO 174: FIRST TO FOURTH SCANNING SIGNAL LINE DRIVE CIRCUITS
181 TO 184: FIRST TO FOURTH VIDEO SIGNAL LINE DRIVE CIRCUITS
20: BACKLIGHT UNIT
G1 TO Gn: SCANNING SIGNAL LINES
S1 TO Sm: VIDEO SIGNAL LINES
DV: VIDEO SIGNAL
HC1 TO HC4: FIRST TO FOURTH HDMI CABLES

1. A display device that divides one frame period into a plurality of sub-frame periods to display an image in a predetermined color in each of the sub-frame periods, the display device comprising:
a display panel including a plurality of pixel formation portions arranged in matrix;
a display control circuit that outputs a video signal to control transmittance of light of the plurality of pixel formation portions in each of the sub-frame periods, based on a digital input signal; and
a plurality of drive circuits that drive the plurality of pixel formation portions based on the video signal, wherein
the plurality of drive circuits drive the plurality of pixel formation portions in parallel, the plurality of pixel formation portions corresponding to a plurality of regions resulting from dividing the display panel into a plurality of portions,
the display control circuit includes:
a signal processing circuit that outputs a plurality of display gradation data groups in parallel based on the digital input signal, the plurality of display gradation data groups corresponding to the plurality of regions; and
a plurality of timing control circuits that are each provided to control each of the plurality of drive circuits, and each receive the display gradation data groups of the corresponding region from the signal processing circuit through a predetermined transmission signal line, and
the transmission signal line is a signal line that can transmit the display gradation data groups in parallel through a predetermined number of transmission paths, the predetermined number being three or more, and transmits the display gradation data groups of a same color in parallel through transmission paths the number of which is not greater than the predetermined number.

2. The display device according to claim 1, wherein the transmission signal line is a cable for a predetermined standard for transmitting the digital input signal, and the timing control circuit and the signal processing circuit are connected by only the one transmission signal line.

3. The display device according to claim 2, wherein the standard is an HDMI standard.

4. The display device according to claim 1, wherein the signal processing circuit allows the transmission signal line to transmit the display gradation data groups of the same color in parallel through transmission paths the number of which is a number obtained by subtracting one from the predetermined number.

5. The display device according to claim 4, wherein the signal processing circuit allows the transmission signal line to transmit data of zero or a value decided beforehand corresponding to one of the display gradation data groups, and the display gradation data groups of the same color, in parallel.

6. The display device according to claim 4, wherein the signal processing circuit generates the display gradation data groups of a gradation bit number q (q is a natural number) larger than a gradation bit number p (p is a natural number) of the display gradation data groups that can be transmitted in parallel by the transmission signal line, and allows the transmission signal line to transmit a part of the display gradation data groups including only the transmittable p bits of the generated display gradation data groups, and data including all data of the remaining (q−p) bits, which corresponds to the display gradation data groups, in parallel.

7. The display device according to claim 1, wherein the signal processing circuit allows the transmission signal line to transmit a plurality of display gradation data groups corresponding to one row to be simultaneously displayed in the region, in arrangement order in which display gradation data to be given to the pixel formation portion located at a distance of half the row along the row is transmitted continuously.

8. A display method in which one frame period is divided into a plurality of sub-frame periods to display an image in a predetermined color in each of the sub-frame periods in a display panel including a plurality of pixel formation portions arranged in matrix, the display method comprising:
a display control step of outputting a video signal to control transmittance of light of the plurality of pixel formation portions in each of the sub-frame periods, based on a digital input signal; and
a plurality of drive steps of driving the plurality of pixel formation portions based on the video signal, wherein
in the plurality of drive steps, the plurality of pixel formation portions corresponding to a plurality of regions resulting from dividing the display panel into a plurality of portions are driven in parallel,
the display control step comprising:
a signal processing step of outputting a plurality of display gradation data groups in parallel based on the digital input signal, the plurality of display gradation data groups corresponding to the plurality of regions; and
a plurality of timing control steps that are each provided to control each of the plurality of driving steps, and each receive the display gradation data groups of the corresponding region from the signal processing step through a predetermined transmission signal line, and
the transmission signal line is a signal line that can transmit the display gradation data groups in parallel through a predetermined number of transmission paths, the predetermined number being three or more, and transmits the display gradation data groups of a same color in parallel through transmission paths the number of which is not greater than the predetermined number.
